(19) United States
(12) Patent Application Publication
(10) Pub. No.: US 2014/0310958 A1
(43) Pub. Date: Oct. 23, 2014

(54) Assembly Method of Wind Power Generation System

(71) Applicant: Hitachi, Ltd., Tokyo (JP)

(72) Inventors: Juhyun YU, Tokyo (JP); Mitsuru SAEKI, Tokyo (JP); Takahiko SANO, Tokyo (JP); Kouhei TANAKA, Tokyo (JP); Shingo INAMURA, Tokyo (JP)

(73) Assignee: Hitachi, Ltd., Tokyo (JP)

(21) Appl. No.: 14/258,714

(22) Filed: Apr. 22, 2014

(30) Foreign Application Priority Data
Apr. 23, 2013 (JP) 2013-089943

(51) Int. Cl. F03D 1/00

(52) U.S. Cl. CPC F03D 1/001
USPC 29/889.21

(57) ABSTRACT

Provided is an assembly method of a wind power generation system that can enhance the safety of an assembly work, and which can reduce a working time. In order to solve the above problem, the assembly method of a wind power generation system of the present invention includes assembly of the wind power generation system which includes a rotor with a hub and blades, a nacelle for accommodating therein at least a generator connected to the rotor via a main shaft connected to the hub, and a tower supporting the nacelle on a top portion thereof, and having an opposite side thereof to the top portion fixed to a foundation, the tower including separated tower parts. When assembling the wind power generation system, the nacelle and the tower are laterally assembled together by using a carriage, and the rotor is fixed to the laterally-facing nacelle.

### CLAIM OF PRIORITY

The present application claims priority from Japanese Patent application serial no. 2013-089943, filed on Apr. 23, 2013, the content of which is hereby incorporated by reference into this application.

### FIELD OF THE INVENTION

The present invention relates to assembly methods of wind power generation systems, and more particularly to an assembly method of a wind power generation system suitable for horizontal assembly of respective components included in the wind power generation system.

### BACKGROUND OF THE INVENTION

Wind power generation systems are getting larger every year in order to improve the efficiency of the power generation. Particularly, in places with fewer restrictions caused by the area of a land or an environment of the land, the wind power generation systems with a power of 5 MW or more have been developed. Such large wind power generation systems have a length of a blade of about 100 m, and an entire length of the wind power generation system close to 150 m.

However, with an increase in size of the wind power generation system, transportation for conveying a wind power generation system, such as a trailer, or a working machine, such as a crane, is also getting larger, which disadvantageously causes many problems, including the increase in cost and time for working on-site.

For this reason, Japanese Unexamined Patent Publication No. 2002-147340 discloses the horizontal assembly of respective components included in a wind power generation system, specifically, that the respective components of the wind power generation system, such as a tower, a nacelle, a hub, and blades are horizontally assembled together using a crane or the like at low elevations.

In general, components of a wind power generation system are normally assembled in turn vertically upward from the bottom thereof with respect to the ground. The large-sized windmill has a height of about 100 m (exceeding 100 m in some cases), and thus has several issues, such as a high risk of working at heights, or high working costs (for example, a high risk of working at high elevations, and high working costs, including expenses for rental of a large-sized crane, conveyance of a crane on-site, construction of a work office, and the like). In the above-mentioned assembly method of the wind power generation system, the components of the system cannot be assembled except for the on-site location. Unlike working in a factory, the on-site working tends to lack preparation, such as working systems, increasing a construction period, and also tends to lack safety systems, increasing a risk of working.

Although Japanese Unexamined Patent Publication No. 2002-147340 has proposed the horizontal assembly of the respective components included in the wind power generation system using a crane at low elevations in order to improve the above-mentioned points, all the respective components are conveyed by the crane, which is problematic in terms of safety, and working stands for putting the respective components thereon are required, which leads to the increase in cost and time. These points are desired to be improved.

The present invention has been made in view of the foregoing points, and it is an object of the present invention to provide an assembly method of a wind power generation system that can reduce a working time while enhancing the safety of the assembly work.

### SUMMARY OF THE INVENTION

In order to achieve the object, an assembly method of a wind power generation system according to the present invention includes assembly of the wind power generation system which includes a rotor having a hub and blades, a nacelle for accommodating therein at least a generator connected to the rotor via a main shaft connected to the hub, and a tower supporting the nacelle on a top portion thereof, and having an opposite side thereof to the top portion fixed to a foundation, the tower including separated tower parts. When assembling the wind power generation system, the nacelle and the tower are laterally assembled together by using a carriage, and the rotor is fixed to the laterally-facing nacelle.

In order to achieve the object, an assembly method of a wind power generation system according to the present invention includes assembly of the wind power generation system which includes a rotor having a hub and blades, a nacelle for accommodating therein at least a generator connected to the rotor via a main shaft connected to the hub, and a tower supporting the nacelle on a top portion thereof, and having an opposite side thereof to the top portion fixed to a foundation, the tower including separated tower parts. The assembly method includes the steps of: laterally assembling the tower by mounting the respective separated tower parts of the tower on carriages while being laterally facing, moving the carriages in this state, and then coupling and fixing the respective separated tower parts; coupling and fixing the nacelle to the uppermost tower part of the laterally-facing tower by mounting the nacelle on a carriage such that the axis direction of the nacelle is oriented in the direction perpendicular to the horizontal direction of the tower, and moving the carriage in this state; and coupling and fixing the rotor conveyed from the air over, to the nacelle.

The present invention has effects that can reduce the working time, while enhancing the safety of the assembly work, and thus is very useful for assembling the wind power generation system.

### BRIEF DESCRIPTION OF THE DRAWINGS

FIG. 1 is a diagram showing a wind power generation system to which an assembly method of the present invention is applied;

FIGS. 2A and 2B are a front view and a side view of the state of supporting a tower by a carriage used in the assembly method of the wind power generation system in the present invention, respectively;

FIGS. 3A to 3F are diagrams for explaining the operation of an alignment mechanism of the carriage used in the assembly method of the wind power generation system in the present invention;

FIG. 4 is a diagram showing the entire structure of the carriage used in the assembly method of the wind power generation system in the present invention;

FIGS. 5A to 5E are diagrams for explaining the assembly work of the tower in the assembly method of the wind power generation system in the present invention;

FIGS. 6A and 6B are diagrams for explaining the assembly of a nacelle to the tower in the state shown in FIG. 5;

FIG. 7 is a flowchart for explaining the assembly method of the wind power generation system in the present invention;

FIG. 8 is a diagram for explaining the assembly of a rotor to the nacelle in the state shown in FIG. 6; and

FIG. 9 is a diagram showing the completion of the assembly of the wind power generation system in the assembly method of the present invention.

### DETAILED DESCRIPTION OF THE PREFERRED EMBODIMENTS

In the following, an assembly method of a wind power generation system in the present invention will be described based on preferred embodiments shown. The same components are designated by the same reference characters through the accompanying drawings.

### First Embodiment

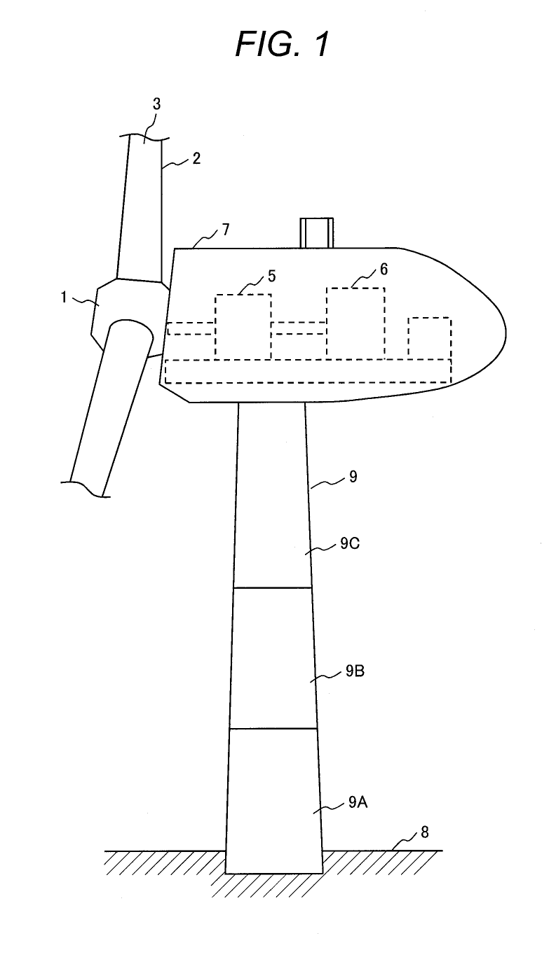

First, before explaining the preferred embodiments of the present invention, a wind power generation system to which the assembly method of a wind power generation system of the present invention is applied will be described below using FIG. 1.

As shown in FIG. 1, the wind power generation system substantially includes a rotor 3 composed of a hub 1 and blades 2, a nacelle 7 for accommodating therein at least a gear box 5 and a generator 6 both connected to the rotor 3 via a main shaft 4 connected to the hub 1, and a tower 9 supporting the nacelle 7 by its top portion, and having an opposite side to the top portion fixed to a foundation 8, the tower 9 including separated tower parts (in this embodiment, three separated parts, namely, a first section tower 9A, a second section tower 9B, and a third section tower 9C).

In this embodiment, when assembling the wind power generation system with the above structure, the nacelle 7 and the tower 9 are laterally assembled together by using carriages to be described later, and the rotor 3 is fixed to the laterally-facing nacelle 7.

More specifically, when assembling the wind power generation system with the above structure, the assembly method includes the step of laterally assembling the tower 9 by mounting the respective separated tower parts of the tower 9 (first section tower 9A, the second section tower 9B, and the third section tower 9C) on carriages while being laterally facing, moving the carriages in this state, and then coupling and fixing the respective separated first section tower 9A, second section tower 9B, and third section tower 9C together. The assembly method also includes the steps of: coupling and fixing the nacelle 7 to the third section tower 9c located on the top portion side of the tower 9 laterally-facing by mounting the nacelle 7 on a carriage such that the axis direction of the nacelle 7 is oriented in the direction perpendicular to the horizontal direction of the tower 9, and moving the nacelle 7 in this state; and coupling and fixing the rotor 3 conveyed from the air over, to the nacelle 7.

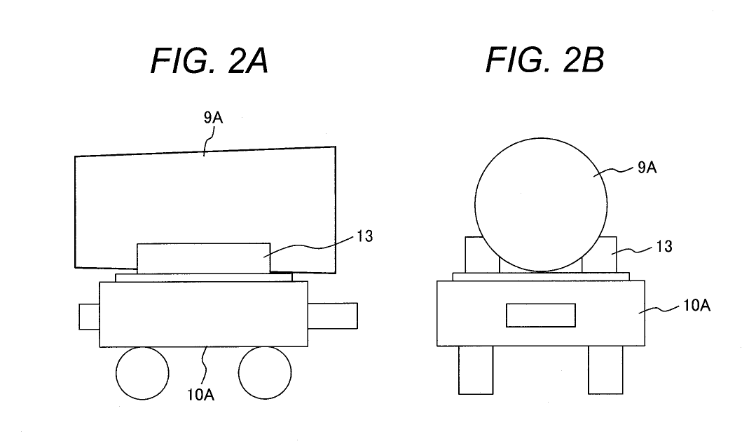

Next, a carriage 10 used in the assembly method of the wind power generation system of this embodiment will be described using FIGS. 2 to 4.

FIGS. 2A and 2B show the state in which the first section tower 9A is supported and fixed by and to a first carriage 10A used in the assembly method of the present invention (the details of which will be described later).

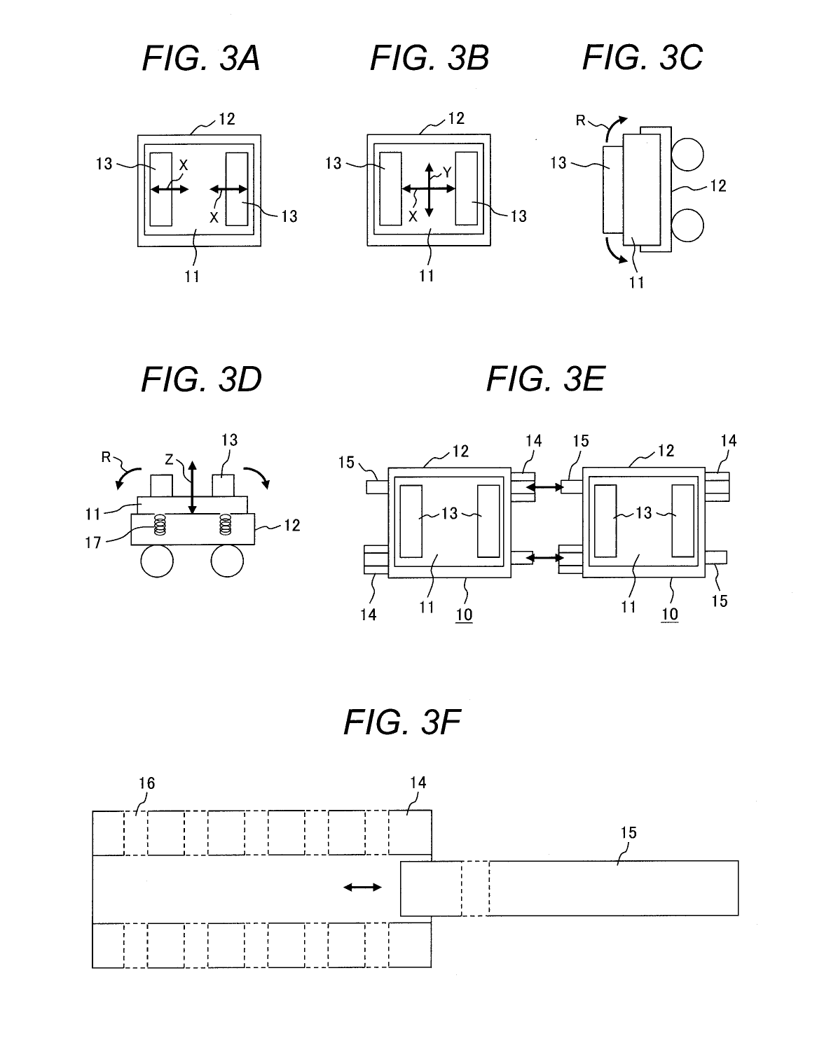

As shown in FIGS. 3A, 3B, 3C, and 3D, the above-mentioned carriage 10 includes a rack 11 and a vehicle body 12. The rack 11 can move in at least two axial directions among three axial directions XYZ (in this embodiment, among three directions, namely, a left-right direction (direction X), a front-back direction (direction Y), and an upper-lower direction (direction Z)) with respect to the vehicle body 12, and also can rotate (change its angle) with respect to at least two axial directions (in this embodiment, in a direction indicated by the arrow R shown in FIGS. 3C and 3D), which constitutes an alignment mechanism.

The alignment mechanism enables fine adjustment of the position of a part (for example, the tower 9) mounted on the rack 11 after the vehicle body 12 is coupled and fixed to a vehicle body 12 of another carriage 10. The rack 11 is provided with a support portion 13 for fixing parts. As shown in FIG. 3A, the support portion 13 moves over a rail (not shown) in the left-right direction (direction X), thereby enabling the fine adjustment of the positions of the parts (for example, tower 9) to support and fix the parts.

Further, as shown in FIGS. 3E and 3F, the vehicle body 12 includes female couplings 14 and male couplings 15. The female coupling 14 and the male coupling 15 can be connected to each other to fix and combine the adjacent carriages 10 together. As shown in FIG. 3F, the female coupling 14 is provided with a plurality of pin holes 16 for fixing the male coupling 15, so that these couplings can be fixed according to the positions of the parts (for example, tower 9) mounted on the two adjacent carriages 10. As shown in FIG. 3D, spring mechanisms 17 are set between the rack 11 and the vehicle body 12, and thus can reduce a load applied on the wind power generation system due to vibration during movement of the carriage 10 as it is.

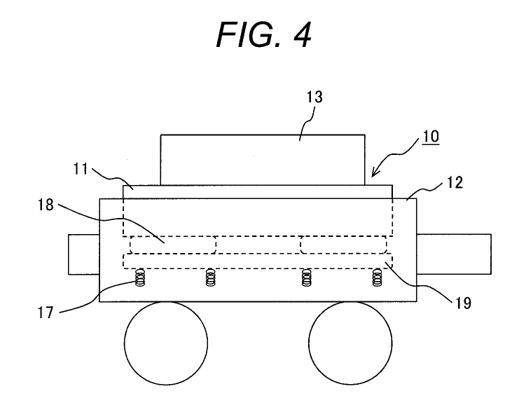

As shown in FIG. 4, the carriage 10 is provided with a hydraulic device 18 between the vehicle body 12 and the rack 11, whereby the force from the hydraulic device 18 mechanically moves the rack 11 with respect to the vehicle body 12.

In this embodiment, the hydraulic devices 18 are disposed in four positions between the rack 11 and the vehicle body 12. Each of the hydraulic devices can be independently moved in the height direction to adjust the height and angle of the rack 11 with respect to the vehicle body 12. Under the hydraulic device 18, a hydraulic motor (not shown) and a guide 19 are mounted, so that the rack 11 can be moved in four directions, namely, in the left-right direction and in the front-back direction on the plane with respect to the vehicle body 12. Spring mechanisms 17 are disposed between the hydraulic motor and a part of the vehicle body 12 under the guide 19. The spring mechanisms 17 can suppress the force transferred to the rack 11 due to vibration or impact of the vehicle body 12.

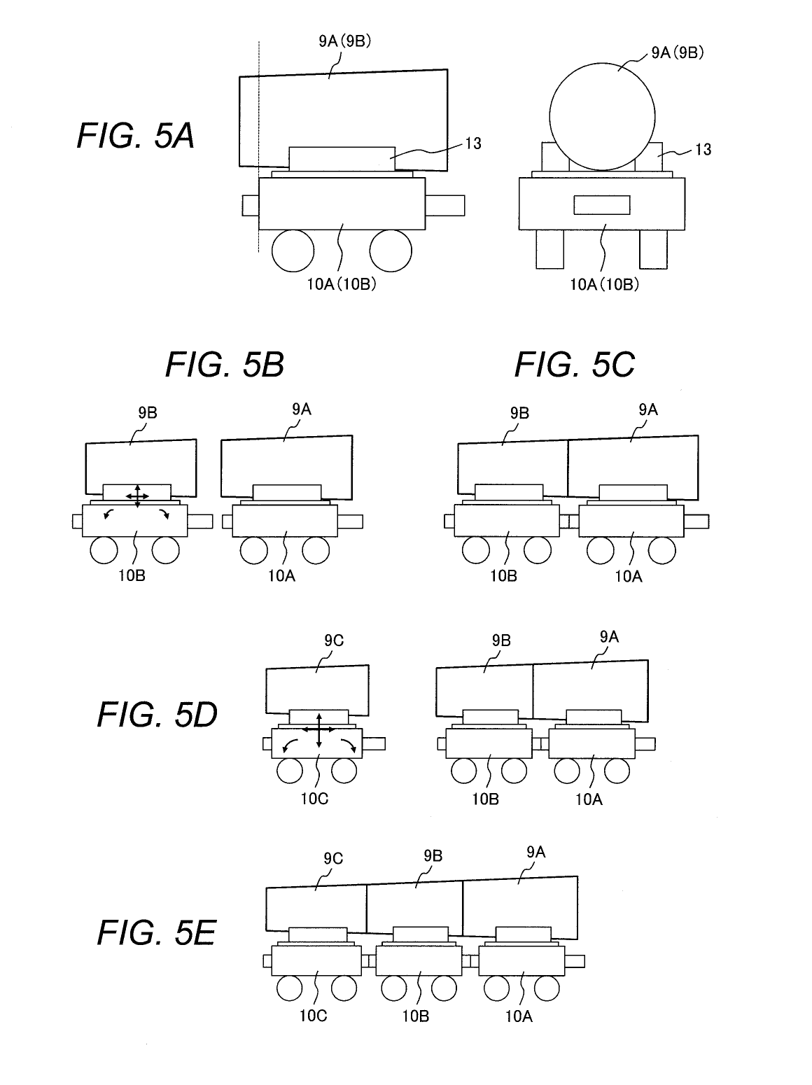

Now, a working procedure for the assembly method of the wind power generation system in this embodiment will be described in detail with reference to FIGS. 5 to 9.

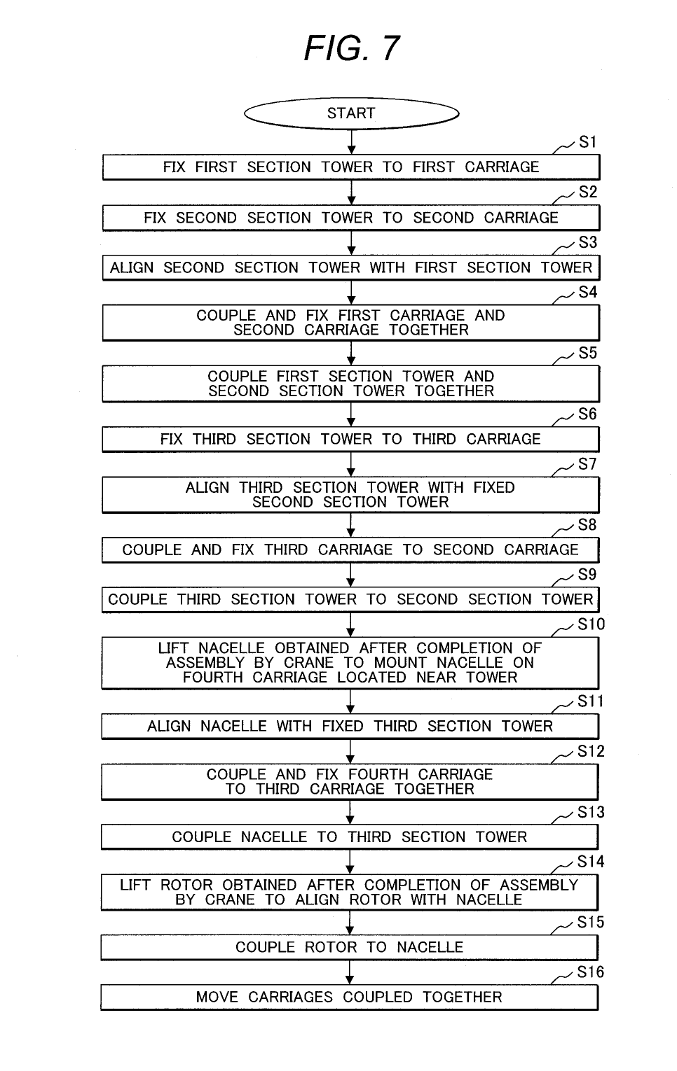

First, the first section tower 9A is laterally fixed to the first carriage 10A (in the direction that makes the axial direction of a cylinder substantially horizontal) (in step 1 of FIG. 7), and the second section tower 9B is laterally fixed to the second carriage 10B (in step 2 of FIG. 7). At this time, as shown in FIG. 5A, a part of the first section tower 9A or second section tower 9B is disposed to protrude outward with respect to the vehicle body 12 of the first carriage 10A or second carriage 10B. The first section tower 9A and second section tower 9B are linearly supported and fixed from the left and right sides by the support portions 13 not to move under the weight thereof.

Then, the first carriage 10A and second carriage 10B with the first section tower 9A and second section tower 9B mounted and fixed thereon, respectively, are moved to cause a connection portion of the first section tower 9A to face a corresponding connection portion of the second section tower 9B as shown in FIG. 5B. The first section tower 9A and second section tower 9B are aligned with each other by the alignment mechanisms of the first and second carriages 10A and 10B (in step 3 of FIG. 7). Further, as shown in FIG. 5C, the first carriage 10A and the second carriage 10B are coupled and fixed together (in step 4 of FIG. 7). Thereafter, the racks 11 are moved by the alignment mechanism to perform the fine adjustment of positions of the first section tower 9A and the second section tower 9B. Further, the first section tower 9A and the second section tower 9B are coupled (in step 5 of FIG. 7).

Next, the third section tower 9C is laterally fixed to the third carriage 10C (in step 6 of FIG. 7). The third carriage 10C with the third section tower 9C fixed and mounted thereon is moved to cause a connection portion of the second section tower 9B to face a connection portion of the third section tower 9C as shown in FIG. 5D. The second section tower 9B and third section tower 9C are aligned with each other by the alignment mechanisms of the second and third carriages 10B and 10C (in step 7 of FIG. 7). Further, the second carriage 10B and the third carriage 10C are coupled and fixed together (in step 8 of FIG. 7). Thereafter, the racks 11 are moved by the alignment mechanism to perform the fine adjustment of positions of the second section tower 9B and the third section tower 9C. Further, the second section tower 9B and the third section tower 9C are coupled (in step 9 of FIG. 7).

In this way, the first section tower 9A, the second section tower 9B, and the third section 9C are coupled together to assembly the tower 9. The state of the tower 9 is shown in FIG. 5E.

In this way, the tower 9 is laterally assembled, which can reduce an occupation time for a large crane, and also can achieve connection work between the components of the tower 9 at the ground level, which is conventionally performed at high elevations. Thus, such assembly can reduce the working time and can also enhance the safety of the work.

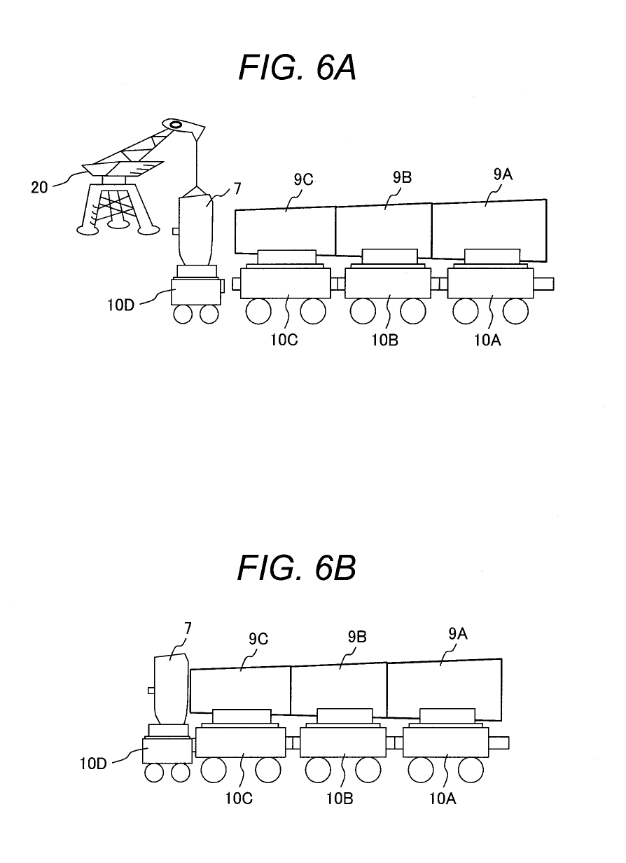

Then, as shown in FIG. 6A, after completion of the assembly of the nacelle 7, the nacelle 7 is lifted by a crane 20, and then mounted and fixed on the fourth carriage 10D located near the tower 9 in such a manner that the axial direction of the nacelle 7 is oriented perpendicular to the horizontal direction of the tower 9 (in step 10 of FIG. 7). After fixing the nacelle 7 onto the fourth carriage 10D, the crane 20 can be removed therefrom, but is desirably used as it is in order to prevent falling of the nacelle.

Then, as shown in FIG. 6B, also in the fourth carriage 10D mounting the nacelle 7 thereon, the nacelle 7 is aligned with the third section tower 9C (in step 11 of FIG. 7). After the alignment therebetween, and then the fourth carriage 10D with the nacelle 7 fixed thereto is coupled and fixed to the third carriage 10C with the third section tower 9C fixed thereto (in step 12 of FIG. 7). Then, after moving the racks 11 to perform the fine adjustment of the positions thereof, the nacelle 7 is coupled to the third section tower 9C (in step 13 of FIG. 7). FIG. 6B shows the state after assembly of the nacelle 7 to the tower 9.

In this way, the nacelle 7 is laterally assembled, which can achieve connection work at the ground level, which is conventionally at high elevations, thus reducing a working time and enhancing the safety of the work.

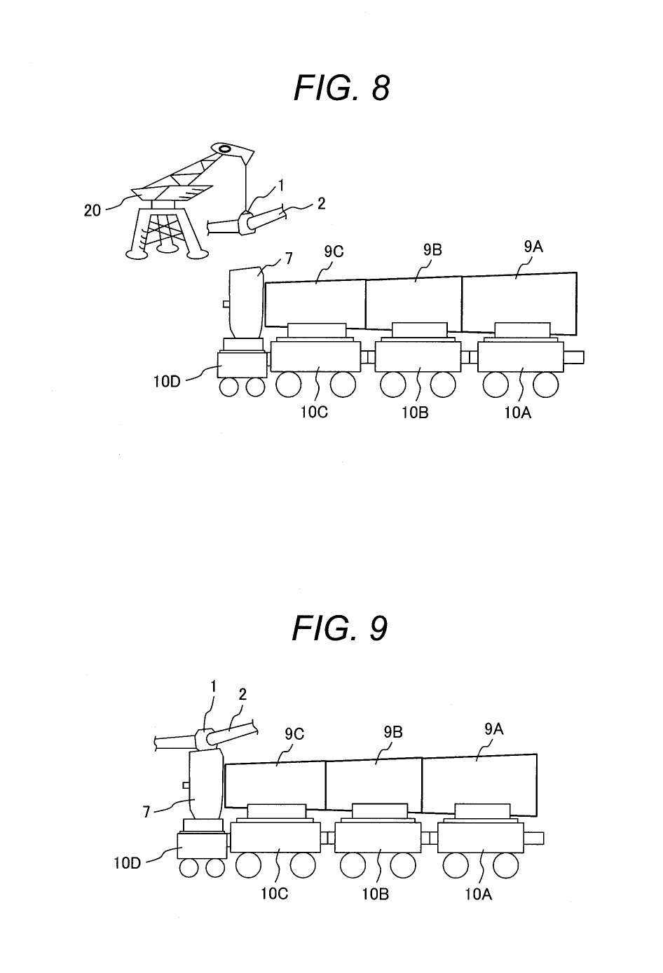

Next, FIG. 8 shows the assembly state of the rotor 3 starting from the state shown in FIG. 6B. The hub 1 and the blades 2 are assembled in advance. After completion of the assembly, as shown in FIG. 8, the rotor 3 is lifted by the crane 20, and moved over the nacelle 7, so that the rotor 3 is aligned with the nacelle 7 (in step 14 of FIG. 7). Thereafter, the rotor 3 is coupled to the nacelle 7 (in step 15 of FIG. 7).

After assembly of the hub 1, the blades 2 can be assembled one by one. In assembling each of the blades 2 separately, a number of means, including a measure for having good balance, a supporting member, and the like are required. However, by mounting the hub 1 including the assembled blades 2 at one time, the assembly can be easily achieved without the necessity of adjusting the balance between the components and using a support member or the like.

Finally, as shown in FIG. 9, after entire completion of the assembly of the wind power generation system, the respective components included in the wind power generation system can be moved to a predetermined place (in step 16 of FIG. 7) while being respectively mounted on the first carriage 10A, the second carriage 10B, the third carriage 10C, and the fourth carriage 10D coupled together.

After the assembly of the wind power generation system near a port, the respective components coupled together and mounted on the first, second, third, and fourth carriages 10A, 10B, 10C, and 10D are transported to the port where a large-sized crane is set, and then can be mounted on a ship or the like.

Further, the wind power generation system of this embodiment is of a downwind type (which is a wind power generation system including the blades 2 disposed behind the nacelle 7 with respect to the wind direction) equipped with coning (with flexible blades: when the wind is strong, the blades 2 are bent in the direction of flow of the wind to receive wind pressure, thereby decreasing air pressure around the system).

The blades 2 are positioned above the nacelle 7, which reduces a risk of contact with the ground or tower 9, enabling the safer transportation.

Such an assembly method of this embodiment has effects that can enhance the safety of the assembly work of the wind power generation system, and which can also reduce the working time.

The present invention is not limited to the above embodiments, and can include various modifications. For example, the above embodiments have been described in detail for easy understanding of the present invention. The present invention is not limited to the structure including all components described above. A part of the structure of one embodiment can be replaced by the structure of another embodiment. The structure of another embodiment can be added to the structure of one embodiment. The addition, deletion, or replacement of another structure can be performed on a part of the structure of each embodiment.

### REFERENCE SIGNS LIST

1 . . . hub

2 . . . blade

3 . . . rotor

4 . . . main shaft

5 . . . gear box

6 . . . generator

7 . . . nacelle

8 . . . foundation

9 . . . tower

9A . . . first section tower

9B . . . second section tower

9C . . . third section tower

10 . . . carriage

10A . . . first carriage

10B . . . second carriage

10C . . . third carriage

10D . . . fourth carriage

11 . . . rack

12 . . . vehicle body

13 . . . support portion

14 . . . female coupling

15 . . . male coupling

16 . . . pin hole

17 . . . spring mechanism

18 . . . hydraulic device

19 . . . guide

20 . . . crane

What is claimed is:

1. An assembly method of a wind power generation system, the wind power generation system comprising a rotor including a hub and blades, a nacelle for accommodating therein at least a generator connected to the rotor via a main shaft connected to the hub, and a tower supporting the nacelle on a top portion thereof, and having an opposite side thereof to the top portion fixed to a foundation, the tower including separated tower parts,
wherein when assembling the wind power generation system, the nacelle and the tower are laterally assembled together by using a carriage, and the rotor is fixed to the laterally-facing nacelle.

2. An assembly method of a wind power generation system, the wind power generation system comprising a rotor including a hub and blades, a nacelle for accommodating therein at least a generator connected to the rotor via a main shaft connected to the hub, and a tower supporting the nacelle on a top portion thereof, and having an opposite side thereof to the top portion fixed to a foundation, the tower including separated tower parts, the assembly method comprising the steps of:
laterally assembling the tower by mounting the respective separated tower parts of the tower on carriages while being laterally facing, moving the carriages in this state, and then coupling and fixing the respective separated tower parts;
coupling and fixing the nacelle to the uppermost tower part of the laterally-facing tower by mounting the nacelle on a carriage such that an axis direction of the nacelle is oriented in a direction perpendicular to a horizontal direction of the tower, and moving the carriage in this state; and
coupling and fixing the rotor conveyed from the air over, to the nacelle.

3. The assembly method of the wind power generation system according to claim 1, wherein the hub and the blade are assembled together in advance, and after completion of the assembly, the rotor is lifted by a crane to move to above the nacelle, aligned with the nacelle, and then coupled to the nacelle.

4. The assembly method of the wind power generation system according to claim 2, wherein the hub and the blade are assembled together in advance, and after completion of the assembly, the rotor is lifted by a crane to move to above the nacelle, aligned with the nacelle, and then coupled to the nacelle.

5. The assembly method of the wind power generation system according to claim 2, wherein after being aligned by an alignment mechanism included in the carriage, the separated tower parts are coupled and fixed together, while the nacelle and the uppermost tower part of the laterally-facing tower are coupled and fixed together.

6. The assembly method of the wind power generation system according to claim 3, wherein after being aligned by an alignment mechanism included in the carriage, the separated tower parts are coupled and fixed together, while the nacelle and the uppermost tower part of the laterally-facing tower are coupled and fixed together.

7. The assembly method of the wind power generation system according to claim 5, wherein the carriage includes a vehicle body and a rack, and the alignment mechanism allows the rack to move with respect to the vehicle body in at least two axial directions of three axial directions X, Y, and Z.

8. The assembly method of the wind power generation system according to claim 5, wherein the carriage includes a vehicle body and a rack, and the alignment mechanism allows the rack to rotate with respect to the vehicle body in at least two axial directions of three axial directions X, Y, and Z.

9. The assembly method of the wind power generation system according to claim 7, wherein the rack of the carriage is provided with a support portion, and the support portion supports and fixes the tower or nacelle onto the rack of the carriage.

10. The assembly method of the wind power generation system according to claim 8, wherein the rack of the carriage is provided with a support portion, and the support portion supports and fixes the tower or nacelle onto the rack of the carriage.

11. The assembly method of the wind power generation system according to claim 5,
wherein the vehicle body is provided with a female coupling and a male coupling, and
wherein the carriages are fixed together by connecting the female coupling with the male coupling.

12. The assembly method of the wind power generation system according to claim 6,
wherein the vehicle body is provided with a female coupling and a male coupling, and
wherein the carriages are fixed together by connecting the female coupling with the male coupling.

13. The assembly method of the wind power generation system according to claim 7,
wherein the vehicle body is provided with a female coupling and a male coupling, and
wherein the carriages are fixed together by connecting the female coupling with the male coupling.

14. The assembly method of the wind power generation system according to claim 8,
wherein the vehicle body is provided with a female coupling and a male coupling, and
wherein the carriages are fixed together by connecting the female coupling with the male coupling.

15. The assembly method of the wind power generation system according to claim 9,
wherein the vehicle body is provided with a female coupling and a male coupling, and
wherein the carriages are fixed together by connecting the female coupling with the male coupling.

16. The assembly method of the wind power generation system according to claim 10,
wherein the vehicle body is provided with a female coupling and a male coupling, and
wherein the carriages are fixed together by connecting the female coupling with the male coupling.

17. The assembly method of the wind power generation system according to claim 5,
wherein a hydraulic device is disposed between the rack and the vehicle body of the carriage, and
wherein the hydraulic device is adapted to adjust a height and/or angle of the rack with respect to the vehicle body.

18. The assembly method of the wind power generation system according to claim 6,
wherein a hydraulic device is disposed between the rack and the vehicle body of the carriage, and
wherein the hydraulic device is adapted to adjust a height and/or angle of the rack with respect to the vehicle body.

19. The assembly method of the wind power generation system according to claim 18,
wherein a hydraulic motor and a guide are set under the hydraulic device, and
wherein the hydraulic motor and the guide cause the rack to move in the front-back and left-right directions on a plane with respect to the vehicle body.

20. The assembly method of the wind power generation system according to claim 19,
wherein a spring mechanism is disposed between the hydraulic motor and the vehicle body under the guide, and
wherein the spring mechanism absorbs vibration of the carriage during moving.
